(19) United States
(12) Patent Application Publication
(10) Pub. No.: US 2019/0296505 A1
(43) Pub. Date: Sep. 26, 2019

(54) ELECTRICAL CONNECTOR

(71) Applicant: ROLI Ltd., London (GB)

(72) Inventors: Laura HARITO, London (GB); Gaetano LING, Palo Alto, CA (US); Murtaza PANJU, London (GB)

(21) Appl. No.: 16/346,433

(22) PCT Filed: Oct. 31, 2017
(86) PCT No.: PCT/GB2017/053268

§ 371 Date: Apr. 30, 2019

(30) Foreign Application Priority Data
Nov. 1, 2016 (GB) 1618447.5

(51) Int. Cl. H01R 24/84; H01R 13/642; H01R 13/62

(52) U.S. Cl. CPC H01R 24/84; H01R 2107/00; H01R 13/6205; H01R 13/642

(57) ABSTRACT

Disclosed herein is an electrical connector for transferring electrical power and data through mating with another electrical connector. The electrical connector comprises an insulating connector housing presenting a mating interface, wherein the mating interface extends in a first plane. The electrical connector further comprises a contact arrangement comprising a plurality of electrical contacts extending at least partially normally to the first plane. The plurality of contacts comprises one or more first pair of electrical contacts arranged to transfer power. The plurality of contacts further comprises one or more second pair of electrical contacts arranged to transfer data, wherein each one or more second pair comprises a receiving contact and a transmitting contact. Each electrical contact in a pair is located symmetrically to the other electrical contact of the pair with regards to a second plane normal to the first plane.

### FIELD

This disclosure relates to an electrical connector. More specifically, but not exclusively, this disclosure relates to electrical connectors which transfer electrical power and data through mating with another electrical connector in an efficient manner that improves and simplifies the connection process.

### BACKGROUND

Electrical connectors are widely used for a large variety of purposes to connect one or more electrical device to other devices. In some systems, to connect two electrical devices an electrical cable is plugged into a port of each device, and the cable carries electrical current between the two devices. This provides a secure and reliable way to connect devices but suffers from the problem of requiring a user to individually plug each end of the cable into each port and this prevents a fast release and reorganisation of the devices to be connected. The cables are likely to get tangled or be in the way if a user attempts to unplug and re-plug the cable into a different device to establish a new device connection.

In some other systems, the connectors are mounted directly on the devices and the connection is made by bring the devices into close proximity and physical contact. This removes the need for cables but introduces additional problems. For example, the devices can no longer use simple ports to connect because two ports do not connect together and instead there needs to be plug-socket relationship between the two device connectors. This restricts the ability to rearrange the devices as there is an additional requirement to fulfil that a plug connector must meet with a socket connector for the two devices to successfully connect.

The above problems are especially acute when designing modular electrical devices. By their nature, modular devices need to attach and detach with a variety of other devices within the modular system. Any restriction of which devices are capable of connecting, or restriction of which parts of each device can connect to other parts of another device, will have a detrimental effect on the modularity of the system.

Additionally, when connectors in a modular system include several contacts, the desire to have many options and ways of arranging the devices and their respective orientations is in conflict with certain limitations regarding which contacts of the connectors need to contact respective contacts of the corresponding connector. Providing high modular versatility increases the problem of how to protect against connectors connecting in a way which either will not work, or causes electrical damage to the connectors and electrical components attached to the connectors.

It would therefore be a substantial improvement over known systems to provide an electrical connector which overcomes some or all of the above disadvantages.

### SUMMARY

An electrical connector is provided for transferring electrical power and data through mating with another electrical connector. The electrical connector comprises an insulating connector housing presenting a mating interface. The mating interface extends in a first plane. The electrical connector further comprises a contact arrangement comprising a plurality of electrical contacts extending at least partially normally to the first plane. The plurality of contacts comprises one or more first pair of electrical contacts arranged to transfer power. The plurality of contacts further comprises one or more second pair of electrical contacts arranged to transfer data. Each one or more second pair comprises a receiving contact and a transmitting contact. Each electrical contact in a pair is located symmetrically to the other electrical contact of the pair with regards to a second plane normal to the first plane.

Each pair of electrical contacts may comprise a first electrical contact protruding at least partially normal to the first plane and a second electrical contact recessed with respect to the first plane.

The insulating connector housing may hold the plurality of electrical contacts in position. The insulating connector housing may define the location of the each of the plurality of electrical contacts in the contact arrangement.

The second plane may define a first region and a second region of the mating interface. The first region may be complementary to the second region such that each location in the first region which protrudes has a symmetric corresponding location in the second region which is recessed.

The mating interface may be a first mating interface and the electrical connector may be a first electrical connector. The first mating interface may be arranged to mate with a second mating interface of a second electrical connector in order to transfer electrical power and data. The second electrical connector may be an electrical connector as provided above. The electrical connector may have substantially the same contact arrangement as the second electrical connector. The first mating interface may be arranged to mate with the second mating interface when the second plane of the first electrical connector is substantially coplanar with a corresponding second plane of the second electrical connector.

The plurality of electrical contacts may further comprise one or more third pair of electrical contacts. The one or more third pair may be ground contacts. On each side of the second plane an electrical contact arranged to transfer data may be located between a ground contact and an electrical contact arranged to transfer power.

The electrical connector may further comprise a plurality of magnets. The plurality of magnets may be arranged into one or more pair comprising a first magnet and a second magnet. A north pole of each first magnet may be located symmetrically to a south pole of the respective second magnet with regards to the second plane.

The plurality of electrical contacts may be arranged substantially linearly. The plurality of electrical contacts may comprise protruding and recessed electrical contacts alternately arranged.

The contact arrangement may comprise six electrical contacts arranged substantially linearly and in the following order: ground contact, contact arranged to transfer data, contact arranged to transfer power, contact arranged to transfer power, contact arranged to transfer data, ground contact.

There is also provided a system comprising a plurality of electrical devices. At least two electrical devices of the plurality of electrical devices each comprise an electrical connector as provided above for transferring electrical power and data through mating with another electrical connector.

### BRIEF DESCRIPTION OF THE DRAWINGS

Exemplary arrangements of the disclosure shall now be described with reference to the drawings in which:

FIG. 1 is a perspective view of an electronic touchpad device;

FIG. 2 illustrates components of the electronic touchpad device of FIG. 1;

FIG. 3 is a perspective view of an electrical connector of the electronic touchpad device of FIG. 1; and

FIG. 4 illustrates an arrangement of magnets of an electrical connector of the electronic touchpad device of FIG. 1.

Throughout the description and the drawings, like reference numerals refer to like parts.

### SPECIFIC DESCRIPTION

In the present disclosure, an exemplary electrical connector is provided as part of an electronic touchpad device for creating music electronically. The electrical connector is arranged such that a first touchpad device can connect to one or more other devices with the same kind of electrical connector in a “genderless” manner. That is, rather than a male-female connector arrangement which connects one type of connector to a second type, i.e. a first “gender” to a second “gender”, the electrical connector of the present disclosure has only one type and is therefore described as “genderless”. In contrast to a conventional pin-and-socket relationship, the electrical connector can connect to any other connector which is substantially similar.

The genderless characteristic of the electrical connector is of particular benefit in a system of devices for creating music electronically. An example of a first device for creating music electronically is a touchpad device, which has an array of pressure sensors underneath a silicone layer forming the touchpad. When a user exerts a force at a certain location on the touchpad, the silicone layer transmits this force to the underlying sensors which record the pressure values at each sensor in the form of electronic signals. The touchpad device is connected to a computer and transmits the signals to the computer which operates software to interpret the electronic signals into audio signals. The audio signals will have different characteristics of pitch, tone, volume, timbre etc. depending on the particular electronic signals produced by the user's input and the settings of the software. In this way, the user has the ability to produce an expansive range of sounds and coordinate these sounds to create musical expressions.

The possibilities for controlling how music is created are increased further by using further devices to add functionality. For example a second touchpad device may be used in collaboration with the first touchpad device, or a device of a different kind can be used such as a device with a number of conventional user input buttons. The second device can be used to modify the functionality of the first device and the way in which the two devices are arranged with respect to each other may affect the characteristics of the music produced. A user can therefore rearrange the positioning and orientation of the devices in the middle of recording or performing music to change the function of the device or create new effects.

The genderless connector of the present disclosure enables this by providing a secure way to disconnect and reconnect two or more devices. The feature that the connector is genderless means that the devices can connect to each other by any individual connector of the first device connecting to any individual connector of the second device. This enhances both the ease of use by the user and also increases the number of functions that the devices can produce.

The connectors can also transmit the signal from one device to another connecting device and vice versa. The devices can therefore be built up in a complex network and the signals produced by each device communicated across the network. The connectors can also transmit power between devices. The features of data and/or power communication increase the versatility of the devices as not all of the devices need to be individually connected to an external power source, or connect to the computer which processes the signals produced by the devices. Instead, if a device is connected via one of the connectors to the network of devices, the signals and power can be passed to and from the rest of the network.

Another advantage of the connectors according to the present disclosure is to prevent connection between two connectors in a manner which may damage the connector or internal components of a device. This is due to: the particular arrangement of contacts that make up part of the connector; the respective functions of the contacts and/or the positioning of the contacts with respect to the functions of the other contacts.

Another advantage of the connectors according to the present disclosure is that magnets may be arranged as part of the connectors or arranged around the connectors to guide the process of connecting two devices via a connector. In particular, having magnets arranged in a genderless manner enables a variety of arrangements of the devices. Also, by including magnets such that the connector has magnets on all sides, two devices will be guided towards a successful connection when they approach from any angle to connect. This increases the ease of connection in a fast and efficient manner.

### Overview of a Device for Creating Music

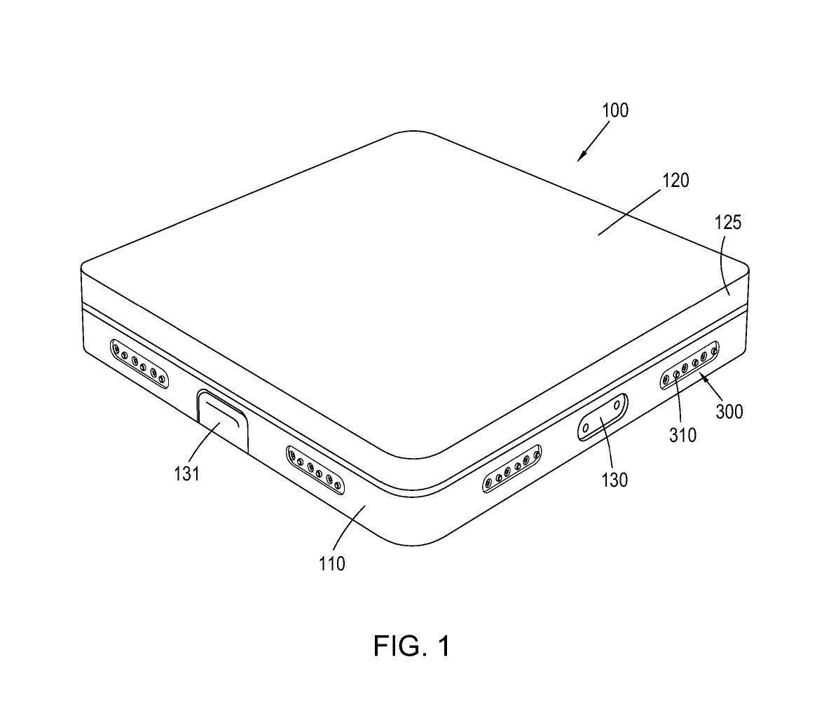

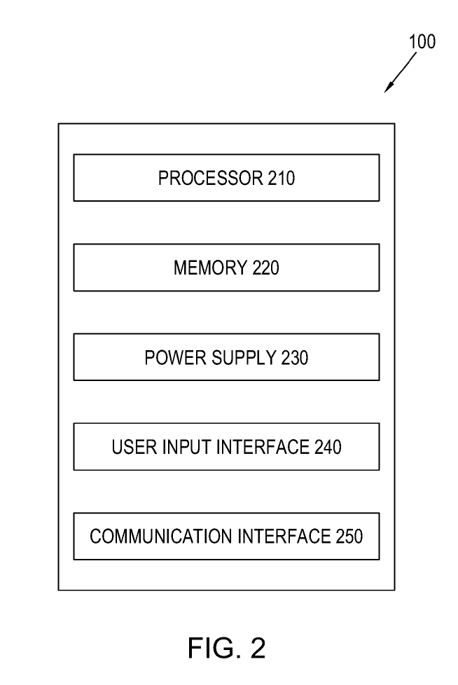

A specific structure of an electronic touchpad device for creating music, which includes genderless electrical connectors, is discussed below in detail with reference to FIGS. 1 and 2.

FIG. 1 illustrates an electronic touchpad device 100 which includes electrical connectors according to the present disclosure. The touchpad device 100 receives user input in the form of pressure input by a user on an upper surface of the touchpad and produces a signal which can be used to create music.

The touchpad device 100 comprises a casing 110 and a user interface surface 120 separated by a deformable layer 125. Underneath the deformable layer 125 is an array of pressure sensors (not shown) which produce a signal when a force is exerted by a user onto the user interface surface 120. The force is transmitted through the deformable layer 125 to the array of sensors. The measurements at the sensors can therefore detect both the location of the user input on the user interface surface 120 but also the force of the user input.

Between the user interface surface 125 and the casing 110 there is also an array of LEDs (not shown) which light up to indicate certain areas of the user interface surface 120 to a user. For example, the LEDs may produce different colours at different locations under the user interface surface 125 to indicate areas that when pressed will produce a particular musical note. The light produced by the LEDs passes through the deformable layer 125 and out of the user interface surface 125 to be visible to a user.

As illustrated by FIG. 1, the touchpad device is cuboid in shape, with a length and width approximately the same and height less than the length and width. In advantageous arrangements, the length and width are exactly the same. For example, the height may be approximately a quarter of the length and width. This produces a slab shape which can easily slide around a worktop or desk without tumbling or rolling. This maintains the orientation with the user interface surface 125 on the upper side of the touchpad device. On side faces of the touchpad device 100 there are one or more electrical connector 300 which is arranged to interface with another similar connector of another device, for example a second touchpad device. The touchpad device according to FIG. 1 includes 8 connectors, with two located on each side face of the touchpad device.

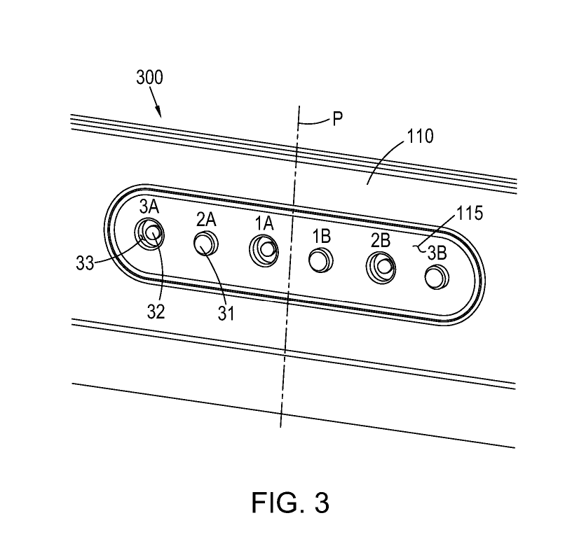

In the arrangement shown in FIG. 3, the connectors 300 each include six electrical contacts 310. In other arrangements, connectors may have a different number of electrical contacts. When each electrical contact is connected to a corresponding electrical contact of another connector, the connectors communicate data and transfer power to each other. The connectors 300 are explained in further detail in FIG. 3.

The touchpad device 100 may also include one or more functional buttons 130, 131 which may have a variety of uses. For example, one button may be a power button for turning the touchpad device on or off. Another button may be a mode toggle button for a user to switch the operation of the touchpad device between different modes of input and/or modes of music creation.

FIG. 2 illustrates components of the electronic touchpad device 100 of FIG. 1. Touchpad device 100 includes a processor 210, a memory 220, a power supply 230, a user input interface 240 and communication interface 250. The processor 210 executes instructions to process data and control each of the components of the touchpad device. The instructions that the processor executes are stored in the memory 220. The memory 220 also stores data from the user input interface 240 as sensed by the sensors in response to a user input or from one or more functional buttons 130, 131. Data from the memory 220 can be retrieved on request by the processor 210 or from an external processing device. The power supply 230 supplies power in the form of electrical energy to the components of the touchpad device 100. The power supply may be a battery which stores electrical energy, or may be connected to an external power source.

The user input interface 240 receives user input from the user interface surface 125 in the form of signals sensed by the sensors of the touchpad device. These signals can be sent to the processor 210, the memory 220 or the communication interface 250. The communication interface 250 can communicate to and from devices other than the touchpad device. The communication may include using electromagnetic radio via one or more antennas, using a wireless protocol, for example WiFi or Bluetooth. The communication can also include using physical connections such as by USB, a power socket, or via one or more connector 300.

The communication interface 250 can communicate data from one or more of the processor 210, memory 220 or user input interface 240 to one or more other devices, for example, via the communication interface of another touchpad device 100. The communication interface 250 also transfers power to or from the power supply 230. The communication interface 250 can receive power from an external power source, such as from the mains or from another device via USB port. The communication interface also transfers power via the connectors 300 to another connector associated with another device, for example another touchpad device 100.

### Connector Arrangement

The connector 300 structure and function is discussed below with reference to FIG. 3. FIG. 3 illustrates an electrical connector of the electronic touchpad device 100.

The particular arrangement of the connector 300 is such that the connector can mate with another connector which is identical, or substantially similar to it. In this way a touchpad device 100 with a number of connectors according to the present disclosure on each side face can be rotated and connected to any side face of another device with matching connectors. Further, this means that the devices can be moved around on a surface and rotated horizontally, maintaining which face of each device faces up, and can still connect to any side of any other device.

A connector 300 is located on a side wall of the touchpad device 100. The connector has six electrical contacts 1A-3A, 1B-3B each of which are connected to wiring or circuitry on the inside of the casing 110. Each of the electrical contacts has a function and is connected to components of the touchpad device according to its function. The electrical contacts are shown in FIG. 3 as conducting pins. The six pins include: two power pins to transfer power 1A, 1B; two signal pins to transfer data 2A, 2B; and two ground pins that are grounded 3A, 3B. The pins are located on the casing in pairs, with a first pin of each pair located on one side of a plane of reflectional symmetry P and the other pin located on the other side of the plane P in a location symmetrical to the first pin. In FIG. 3, this can be seen as there are three pairs of pins, an A pin and a B pin for each pair. The A and B pins are located symmetrically on either side of the plane of reflectional symmetry P. In the arrangement illustrated by FIG. 3, the pins are arranged substantially linearly. This improves the manufacturing efficiency and is especially advantageous for including in a device which has a smaller height than length and width. The linear arrangement in this case may be substantially horizontal. That is, from left to right across the face of the side wall the pins are in the order of: 3A, 2A, 1A, 1B, 2B, 3B. This linear arrangement of pins reduces the required height of the device and this allows for a device with a lower centre of gravity which can be slid around a surface more easily without flipping or tumbling.

In other arrangements the pins may not be arranged horizontally or linearly but in some other symmetrical pattern.

Each pair of pins has the same role as the other pin in its pair. In this way the two power pins 1A, 1B are located symmetrically across the plane P of symmetry and likewise for the two signal pins 2A, 2B and the two ground pins 3A, 3B. Therefore when two connectors with an arrangement of pins as described above face each other pin-to-pin, the power pins, signal pins and ground pins of the first connector respectively align with the power pins, signal pins and ground pins of the other connector. Once electrical contact is made between the pins, the signal pins can then transfer data across the connector, the power pins can transfer power across the connector and the two connectors share a common ground.

In general there are two types of electrical contacts that are included in a connector 300. A first type of electrical contact (“type 1” pins) successfully connects when it comes into contact with another electrical contact with the same role. For example, power pins will successfully connect with another power pin to transfer power and there is no distinction in the role between the two power pins. Likewise ground pins come into contact and share ground without distinguishing the roles between each pin. A second type of electrical contact (“type 2” pins) successfully connects when it comes into contact with another electrical contact with a different but complementary role. For example, signal pins can connect with one pin having a transmitting role and the other signal pin having a receiving role. If a transmitting signal pin comes into contact with another transmitting signal pin, this may simply have no effect such that data cannot be transferred across the connector. This may be because of certain circuitry requirements within a device which communicates via the connector 300.

In the arrangement of electrical contacts as shown by FIG. 3, type 1 electrical contacts, i.e. the power pins 1A, 1B and the ground pins 3A, 3B, are arranged in pairs with one of each pair located on each side of plane of symmetry P and both having the same role. Type 2 electrical contacts, i.e. the signal pins 2A, 2B, are arranged in pairs with one of each pair located on each side of the plane of symmetry P and one having a first role and the other having a second complementary role. Hence the first signal pin 2A has a receiving role and the second signal pin 2B has a transmitting role. In an alternative arrangement the first pin 2A could be the transmitting pin and the second signal pin 2B would therefore be the receiving pin.

In addition to the above conditions under which connectors may connect with another connector, i.e. regarding the function of the electrical contacts and their respective roles, there may be further conditions to connect. For example, a further condition may be the physical shape of the electrical contacts matching. As can be seen in FIG. 3, each electrical contact is either a protruding pin 31 or a recessed pin 32 located in a pin recess 33. When two connectors meet, the structure of the connector is designed such that a protruding pin 31 of a first connector will contact a recessed pin 32 of the second connector and vice versa. This is achieved by having one pin in each pair of pins being a protruding pin 31 and the other pin in each pair being a recessed pin. As discussed above, the first and second pins of each pair are located symmetrically across the plane of symmetry P. Therefore, when a second connector with the same pin arrangement approaches a first connector pin-to-pin, protruding pins 31 will align with recessed pins 32 and the two connectors can physically mate. The connector arrangement of FIG. 3 is such that the six pins alternate between recessed pins 3A,1A,2B and protruding pins 2A,1B,3B thereby creating a more secure engagement with a second connector.

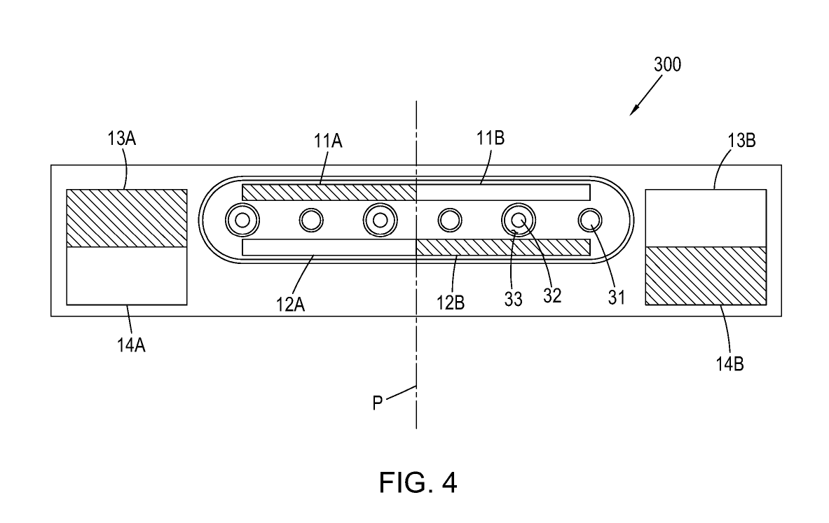

When two connectors physically mate, the pins from a first connector physically contact the corresponding pins of a second connector. The two connectors may be held together by securing mechanism such as an arrangement of magnets surrounding the electrical contacts as described in further detail below with respect to FIG. 4. Alternative securing mechanisms include a latch mechanism, a screw mechanism or any other suitable means for securing the two connectors such that all the electrical contacts are in contact with their corresponding electrical contact. The recessed pins 32 may be sprung, for example by including a resilient member such as a metal spring behind each recessed pin. When the second connector comes into secure connected state with the first connector, the protruding pins 31 of the second connector contact the recessed pins 32 of the first connector and depress recessed pins and deform the spring behind each recessed pin. When the two connectors are securely held in place, the spring maintains a firm contact between the protruding and recessed pins. The same mechanism occurs for the protruding pins of the first connector and the corresponding recessing pins of the second connector. This improves the connection quality between the connectors. Alternatively or additionally, the protruding pins may be sprung.

In some arrangements, the protruding pin 31, recessed pins 32 and pin recesses 33 are all located on a recessed portion 115 of the casing 110. This allows the connector to more easily connect to a second connector. This is because when the second connector approaches the first connector, the protruding pins 31 can approach from an angle other than directly head on. That is, because the pins are located in a recessed portion 115 of the casing, a user in control of two connectors can connect them in a more simple and efficient manner. In the alternative where the protruding pins 31 and pin recesses 33 are on a flush surface of the casing, the protruding pins 31 are more likely to get prevented from entering the pin recesses 33 when there is a slight misalignment between them.

The contact arrangement is held in place by the casing 110, which maintains the pins in a fixed location with respect to each other. The casing holds the pins separate and is made at least in part from an insulating material so that there is no conduction between pins. Although the casing 110 performs this role in the presently described arrangement, in general any insulting connector housing may be used. The insulating connector housing may be an integral part of the casing 110 of the touchpad device 100, or may be a separate piece which is attached to the touchpad device to define the location of the pins. As in the present arrangement, the insulating connector housing may be a single piece with holes for the pins to pass through from the inside of the device. This connects internal components to the outside of the device in order to connect to another connector. In alternative arrangements, the insulating connector housing may instead hold the pins in place with one or more stand, clip or any other mounting means. Furthermore, while the term insulating connector housing is used, the housing only needs to be insulating insofar as that there is no conducting pathway between pins. Hence the insulating connector housing may not be made exclusively of insulating material, such as plastic, provided that it insulates the pins from each other.

The insulating connector housing, such as casing 110 in the presently described arrangement, presents a mating interface. The mating interface is the region of the connector 300 which mates with another mating interface of a second connector when the two connectors connect. The mating interface may therefore include the contact arrangement, e.g. the pins. The mating interface may also include any physical connection means for securing the connector with another connector, such as a magnet arrangement, clips, etc.

In general the mating interface extends in a plane of mating. In the arrangement of FIG. 1, this plane is substantially coplanar with the side face of the touchpad device 100 on which the connector 300 is located. The pins 31, 32 of the connector in FIG. 3 extend at least partially normal to the plane of mating. For example, each pin 31, 32 of the connector extends at least partially normal to the face of the casing 125. In particular, the mating end of each pins is normal to the extent that it can contact a pin of the connector which it is mating with. The pin of the other connector likewise has its mating end normal to its respective mating interface such that the mating ends of the pins contact each other head on. The pins may be partially normal to the plane of mating and protrude from the mating interface. It is also possible that a pin is recessed from the plane of mating but is partially normal to the plane of mating, for example, if it still extends in the direction normal to the plane of mating even though it is behind the plane or does not cross the plane. It is also possible that the end of the pin is coplanar with the mating interface and still extends partially normally to the plane of mating as it is still arranged to mate with another pin in the direction normal to the plane of mating.

The plane of mating in which the mating interface extends is normal to the plane of symmetry P. This is so that when two connectors face each other in order to mate, i.e. their respective planes of mating are substantially parallel or coplanar, their planes of symmetry P can align. As discussed above, this allows for the contact arrangements of the two connectors to connect. The mating interface is therefore divided into two regions by the plane of symmetry P.

As illustrated by FIG. 3, the mating interface may be substantially planar. However, in some arrangements the mating interface may be non-planar and have locations which protrude substantially normally to the plane of mating and have locations which recess. In these arrangements, each portion of the mating interface which protrudes on one side of the plane of symmetry may correspond to a recessed portion on the other side of the plane of symmetry. This allows the mating interface to physically mate with another mating interface of the same or similar arrangement, with recessed and protruding portions of each mating interface aligning to mate. The extent to which the amount each portion protrudes or recesses to complement the portions on the other side of the plane will depend in part on the pins, in particular, how much clearance the pins have with respect to the connector housing which presents the mating interface.

The insulating connector housing, such as casing 110 may have upper and lower faces, where the upper face is substantially parallel to the lower face as part of a cuboid shape. The mating interface may therefore be on a face of the casing which extends between the upper and lower face substantially normal to the upper and lower faces.

### Contact Arrangement to Prevent Incorrect Connection

The arrangement of the electrical contacts is such that it prevents incorrect contacts connecting. In particular where there are electrical contacts of a certain function which may cause damage if they connect to an electrical contact of a different function, the risk of this occurring can be minimised by the arrangement of contacts. For example, where a connector includes both power pins and ground pins, if these pins contact, it may cause a short circuit or polarity reversal and potentially damage electrical components within the touchpad device circuitry.

The present arrangement will be described with the pin arrangement of FIG. 3. However, this is in no way limiting the present disclosure to this particular arrangement. This meant as exemplary only, there are of course many different particular arrangements of pins which are envisaged.

A first way in which incorrect contact arrangements may align is when one device is flipped. An incorrect alignment may be avoided by arranging the pins such that they are symmetrical. In this case, if the touchpad device 100 is inverted and brought into contact with a second touchpad device, no dangerous connections will be made. This is because turning the connector upside-down will maintain a pin arrangement with where pins of the same function align. That is, the power pins of the inverted connector will align with the power pins of the non-inverted connector and likewise with the signal pins and ground pins. In this orientation type 2 pins, which make up pairs of complementary roles, will not align. Instead the inverted connector's transmitting signal pin will align with the non-inverted connector's transmitting signal pin and likewise for the receiving signal pins. There will therefore be no data communication between the two connectors, but a common ground is maintained and the connectors are still able transfer power across the connectors. Furthermore, there are no connections made that will cause electrical damage as power pins do not contact ground pins and power polarity is maintained.

Another situation which may cause an incorrect connection is when two connectors are forced together with offset pin alignment. In a six pin linear arrangement with pins alternating between protruding and recessed, a “one-off” pin misalignment will cause a protruding pin from the first connector to contact a protruding pin of a different function from the other connector. For example, referring to the arrangement of FIG. 3, if a second connector approaches the first connector 300 with a pin misalignment shifted one to the left the protruding signal pin 2A of the second connector will contact protruding power pin 1B of the first connector 300. Likewise, the protruding power pin 1B of the second connector will contact protruding signal pin 2A. This will not cause damage to the circuit as, for example, the signal pins may have resistors that join them to the rest of the circuit and therefore dissipate power rather than conduct it to more sensitive circuit components. Alternatively, the signal pins may be attached to an electrical device which prevents the transmission of power when a high input power is present. Hence in the arrangement of FIG. 3, a misalignment of pins by one does not cause a risk of electrical damage as there is no power to ground contact and the internal circuit is protected from damage when power and signal pins contact.

If a different pin arrangement to FIG. 3 were chosen such that on each half of the connector a ground pin were adjacent to a power pin, then a one-off pin misalignment would cause a power to ground short-circuit and potentially damage the internal circuit. For example, if the location of the ground pins were at the location of pins 2A and 2B in FIG. 3 and power pins remain at 1A, 1B an accidental misalignment would be more likely to cause electrical damage. Therefore, by arranging the pins such that a signal pin is located between the power and ground pins, the connector has improved safety by reducing the likelihood of a short circuit or polarity reversal event. This also have the beneficial effect of improving the ease of connecting two connectors as this can be done effectively without the need to perfectly align the pins before bringing the connectors into contact.

In alternative arrangements in which the pins are not arranged linearly, the power pins and ground pins may be located at different and non-overlapping heights. This provides protection from damage resulting from pin misalignment. This is because if the two connectors are on a level surface, no amount of lateral misalignment will bring the power and ground pins into contact.

Another way in which the connector can prevent incorrect pins contacting is using magnets to both secure two connectors together by magnetic attraction and to align the corresponding pins on each connector. The magnetic securing mechanism is described below with respect to FIG. 4.

Any of the above arrangements for preventing incorrect contact alignment and/or connection can be used alone or in combination with the other arrangements for preventing incorrect contact alignment and/or connection.

### Magnetic Securing Mechanism

FIG. 4 illustrates an arrangement of magnets of an electrical connector of the electronic touchpad device according to present disclosure.

A plurality of magnets are located behind the casing 110 and are arranged so that when a second connector with the same arrangement of magnets approaches face on, the magnets will create a force between the two connectors. The magnetic force attracts the two connectors together so that they are held firmly with their respective pins in contact with each other. The magnetic force also aligns the two connectors so that the pins of the first connector line up directly with their corresponding pins of the second connector.

In order for a connector with magnets to be genderless, the magnets can be arranged in such a way that the north pole of each magnet in the first connector faces a south pole of a magnet in the second conductor. This is done by arranging the magnets of the connector 300 in pairs located symmetrically across a plane of reflectional symmetry P. One magnet of each pair has its north pole facing outward from the connector and the other magnet in each pair having its south pole facing outward from the connector. As shown in FIG. 4, the north pole of magnet 11A is located symmetrically across plane P from the south pole of magnet 11B. Each magnet is located symmetrically to its pair and in a complementary sense regarding which polarity faces outwardly from the connector. In FIG. 4, north poles are shown filled in with diagonal lines and south poles are shown with no fill pattern.

When a second connector with the same magnet arrangement as the first connector approaches, the magnets exert a force on each opposite connector. If the connectors are misaligned, the north poles of the magnets on each connector will repel one another, and likewise for the south poles, and the connectors will be prevented from approaching further to connect. Alternatively, if the connectors are approximately aligned, the north poles from first connector will face south poles from the second connector, and vice versa, and the magnets of each connector will attract one another and be pulled together and held in place with the correct pin alignment. Using this arrangement of magnets to secure two connectors together with the correct pin alignment happens because the same plane of symmetry P about which the pairs of electrical contacts is symmetrical is the same as the plane of symmetry P about which the magnets are symmetrical.

Arranging the magnets of the connector in symmetrical complementary pairs as shown in FIG. 4, also has the advantageous effect that it prevents two connectors from making contact with their respective pins when one of the connectors is inverted. This is because the arrangement of magnets is not symmetrical about a plane orthogonal to the plane of symmetry P and substantially parallel to the top and bottom surfaces of the touchpad device. If there were an plane of symmetry parallel to the user interface surface 125 of the touchpad device illustrated by FIG. 1 with opposite poles located symmetrically, inverting one connector would not affect the connection attraction between the two connectors. In contrast, as shown in FIG. 4, the magnet 11A and 12A form a symmetrical complementary pair which has the same plane of symmetry (not shown) as the magnet pair 11B and 12B. The magnet 13A and 14A also form a symmetrical complementary pair with the same plane of symmetry (not shown) as the magnet pair 13B and 14B. However, the plane of symmetry for the pairs 11A, 12A and 11B, 12B is different to the plane of symmetry for the pairs 13A, 14A and 13B, 14B. The result of this discrepancy means that an inverted second connector does not attract the first connector.

If the magnet arrangement of FIG. 4 is inverted and brought face on into proximity with a non-inverted magnet arrangement of the same layout, north poles 13A and 14B from the inverted connector would align with south poles 14A and 13B of the non-inverted connector respectively and be attracted, and vice versa. However, in this orientation, south pole 12A of the inverted connector will be facing south pole 12A of the non-inverted connector and likewise for the two 12B north poles. Hence the attraction and repulsion between different pairs of magnets are in conflict and the connectors will not mate. Alternatively if the inverted connector is raised with respect to the non-inverted connector, the south poles 12A and 11B of the inverted connector align and attract the north poles 11A and 12B of the non-inverted connector respectively, and vice versa. However, in this orientation the south pole 13B of the inverted connector will face the south pole 13B of the non-inverted connector and likewise for the respective north poles 13A of the two connectors. Hence in this orientation the attraction and repulsion of different pairs of magnets are in conflict and also will not mate. Because there is there is no plane of symmetry which is horizontal, i.e. parallel to a surface on which the devices sit, the connector will not mate with a second connector with an inverted magnet arrangement. This increases the ease of use by a user by making connections between connector devices in an effective way with minimal trial and error.

The above arrangement for preventing mating between inverted and non-inverted is improved by the fact that the plane of symmetry of one set of pairs 13A,14A and 13B,14B passes through one or more other magnets. In the example of FIG. 4, this the plane of symmetry of 13A,14A and 13B,14B passes through magnets 12A and 12B. This means that when the connector is inverted, magnets 12A and 12B do not substantially change location between the inverted and non-inverted connectors and therefore will repel one another when they approach. Likewise, the plane of symmetry of 11A,12A and 11B,12B passes through magnets 13A and 13B. The result of this when the connector is inverted about a plane of symmetry for one set of pairs so that complementary poles face each other, at least one other magnet has not changed position during the inversion and hence repels the corresponding magnet of the other connector.

The arrangement of magnets, due to the symmetry about a vertical plane P, means the touchpad device 100 can connect with any side of another device when rotated and moved around on a substantially flat surface. Meanwhile asymmetry about a horizontal plane means that touchpad devices will only connect when they are the same way up.

The number and locations of the magnets can also be beneficial to the ease for a user to connect touchpad devices together. This is due to magnets being arranged above and below the electrical contact arrangement in addition to either side. This has the result of the magnet arrangement guiding two connectors together from a greater range of angles. For example, if a user holds a touchpad device between the user's forefinger and thumb and places the touchpad device next to a second touchpad device it will in general approach second touchpad device with the side face with a connector angled down. By having elongate magnets, such as magnets 11A and 11B above the electrical contact arrangement, the force which arises between the two connectors of the two touchpad devices will engage at an earlier stage in the connection motion than other magnets located to the sides of the electrical contact arrangement.

Although the above description provides a particular device and connector arrangement, the principles disclosed herein can be implemented in a variety of other ways.

To provide a genderless contact arrangement, the electrical contacts are arranged in pairs located symmetrically on either side of a plane of symmetry. However, there is no restriction to the number of electrical contacts. Although six electrical contacts are described above with respect to the figures, the electrical contact arrangement may include fewer or more. Additionally, although the electrical contacts are described as being arranged linearly, the contacts may alternatively be arranged in a 2-dimensional array or any other pattern provided that it meets the criterion of symmetry. There is also no limitation to a pattern of which electrical contacts protrude and which are recessed. Therefore, while in the above examples the pins alternate between recessed and protruding pins, in alternative arrangements there may be a different pattern. For example all the pins on a first side of the plane of symmetry may be recessed pins and all the corresponding pins on the other side of the plane of symmetry would therefore be protruding pins. The pins themselves may not be cylindrical and can in general be any shape provided that each shape of each pin in a pair of pins is symmetrical to the shape of the other pin in its pair.

There is also no limitation to the size, shape or dimensions of the device which the electrical connector described herein connects to or from.

Each pair of symmetrically positioned electrical contacts has the same function as the other in its pair. The examples described above are electrical contacts to: transfer data, transfer power or share ground. The functions of electrical contacts are not limited to these examples and may include functions such as an alarm signal, a stand-by request, a power down request etc. For certain functions, the pairs may be made up of electrical contacts with different roles such as transmitting and receiving.

While the connector 300 is described above in the context of being part of or mounted onto a touchpad device for creating music, the connector may likewise be on other different devices as part of the same system for creating music. These may include a speaker device, controller devices with input buttons rather than a user input surface 120, or any other functional device which may be part of the system. Furthermore, the connector 300 is not limited to devices for music production or audio processing and can be used in any form of electrical device that requires connection with one or more other devices.

1. An electrical connector for transferring electrical power and data through mating with another electrical connector, the electrical connector comprising:
an insulating connector housing presenting a mating interface, wherein the mating interface extends in a first plane;
a contact arrangement comprising a plurality of electrical contacts extending at least partially normally to the first plane, the plurality of contacts comprising:
one or more first pair of electrical contacts arranged to transfer power;
one or more second pair of electrical contacts arranged to transfer data,
wherein each one or more second pair comprises a receiving contact and a transmitting contact;
wherein:
each electrical contact in a pair is located symmetrically to the other electrical contact of the pair with regards to a second plane normal to the first plane.

2. The electrical connector of claim 1, wherein each pair of electrical contacts comprises a first electrical contact protruding at least partially normal to the first plane and a second electrical contact recessed with respect to the first plane.

3. The electrical connector of claim 1, wherein the insulating connector housing holds the plurality of electrical contacts in position, wherein the insulating connector housing defines the location of the each of the plurality of electrical contacts in the contact arrangement.

4. The electrical connector of claim 1, wherein the second plane defines a first region and a second region of the mating interface, wherein the first region is complementary to the second region such that each location in the first region which protrudes has a symmetric corresponding location in the second region which is recessed.

5. The electrical connector of claim 1, wherein the mating interface is a first mating interface and the electrical connector is a first electrical connector, wherein the first mating interface is arranged to mate with a second mating interface of a second electrical connector in order to transfer electrical power and data.

6. The electrical connector of claim 5, wherein first electrical connector has substantially a same contact arrangement as the second electrical connector.

7. The electrical connector of claim 5, wherein the first mating interface is arranged to mate with the second mating interface when the second plane of the first electrical connector is substantially coplanar with a corresponding second plane of the second electrical connector.

8. The electrical connector of claim 1, wherein the plurality of electrical contacts further comprises:
one or more third pair of electrical contacts, wherein the one or more third pair are ground contacts.

9. The electrical connector of claim 8, wherein on each side of the second plane an electrical contact arranged to transfer data is located between a ground contact and an electrical contact arranged to transfer power.

10. The electrical connector of claim 1, further comprising a plurality of magnets, wherein the plurality of magnets are arranged into one or more pair comprising a first magnet and a second magnet, wherein a north pole of each first magnet is located symmetrically to a south pole of the respective second magnet with regards to the second plane.

11. The electrical connector of claim 1, wherein the plurality of electrical contacts are arranged substantially linearly.

12. The electrical connector of claim 11, wherein the plurality of electrical contacts comprises protruding and recessed electrical contacts alternately arranged.

13. The electrical connector of claim 1, wherein the plurality of electrical contacts of the contact arrangement comprises six electrical contacts arranged substantially linearly and in the following order: ground contact, contact arranged to transfer data, contact arranged to transfer power, contact arranged to transfer power, contact arranged to transfer data, and ground contact.

14. A system comprising a plurality of electrical devices, wherein at least two electrical devices of the plurality of electrical devices each comprise at least one electrical connector according to claim 1.
